(19) United States
(12) Patent Application Publication
(10) Pub. No.: US 2024/0037638 A1
(43) Pub. Date: Feb. 1, 2024

(54) INTERACTIVE RETAIL CUSTOMER INTERFACE

(71) Applicant: Outform Ltd., Moshav Magshimim (IL)

(72) Inventor: Ariel Haroush, North Miami, FL (US)

(73) Assignee: Outform Ltd., Moshav Magshimim (IL)

(21) Appl. No.: 18/226,366

(22) Filed: Jul. 26, 2023

Related U.S. Application Data
(60) Provisional application No. 63/392,657, filed on Jul. 27, 2022.

(51) Int. Cl. G06Q 30/0601

(52) U.S. Cl. CPC G06Q 30/0641

(57) ABSTRACT

Interactive retail customer interfaces include a housing defining the shape of the interactive retail customer interface, adapted and configured to secure and contain operable components of the interactive retail customer interface, a sensor adapted and configured to receive identifying data related to a selected retail product, a display adapted and configure to provide relevant information to a user relating to the selected retail product, a user interface adapted and configured to receive user input in response to the displayed relevant information, and a controller programmed to receive identifying data from the sensor, programmatically provide data to the display, and respond to user input from the user interface.

### CROSS-REFERENCE TO RELATED APPLICATIONS

This application claims the benefit of priority to U.S. Patent Application Ser. No. 63/392,657, filed Jul. 27, 2022, which is incorporated herein by reference in its entirety.

### BACKGROUND OF THE INVENTION

Retail electronic equipment has historically been limited to use by store employees, as in the cases of cash registers, back-end computers and inventory control devices. A store employee is still required to answer simple retail customer questions, such as questions related to availability of variations in size and color of merchandise on display.

Given the prevalence of electronic devices in modern life, and the comfort of a large portion of the global population in using such devices, Applicant conceives that the implementation of electronic self-service devices within a retail space can advantageously provide a retail customer with quick and satisfactory responses to frequently asked questions, while reducing burden on retail staff. The devices, systems and related methods of the present disclosure provide solutions to this end.

### SUMMARY OF THE INVENTION

In accordance with the present invention, devices, systems and methods are provided that enhance and streamline the retail experience and reduce the burden on retail staff.

In accordance with one aspect of the invention, an interactive retail customer interface is provided, including a housing defining the shape of the interactive retail customer interface, adapted and configured to secure and contain operable components of the interactive retail customer interface, a sensor adapted and configured to receive identifying data related to a selected retail product, a display adapted and configure to provide relevant information to a user relating to the selected retail product, a user interface adapted and configured to receive user input in response to the displayed relevant information, and a controller programmed to receive identifying data from the sensor, programmatically provide data to the display, and respond to user input from the user interface.

The sensor can be a radio-frequency ID sensor, optical sensor or other suitable sensor, depending on the precise implementation.

The user interface can include one or more touch-sensitive screens and/ or one or more physical buttons. The user interface can include a displayed quick response (QR) code, allowing a user to control the interface remotely through a mobile device.

Interactive retail customer interfaces in accordance with the invention can further include a data connection to external database to retrieve inventory information. Such data connection can be wireless.

Interactive retail customer interfaces in accordance with the invention can further include a power supply, which can be a battery. Alternatively power transformers and the like can be utilized.

Interactive retail customer interfaces in accordance with the invention can further include an illuminated feedback indicator. Such illuminated feedback indicators can extend around a sensor area.

Interactive retail customer interfaces in accordance with the invention can further include a floor-mounted pedestal, and/or can be integrated into a retail display fixture and/ or can be integrated into retail fitting room furniture.

### BRIEF DESCRIPTION OF THE DRAWINGS

So that those skilled in the art to which the subject disclosure appertains will readily understand how to make and use the devices, systems and related methods of the subject disclosure without undue experimentation, embodiments thereof will be described in detail herein below with reference to certain figures, wherein:

FIG. 1 is an isometric view of an interactive retail customer interface according to a first embodiment of the present invention;

FIG. 2 is an isometric view of the interactive retail customer interface of FIG. 1, provided in connection with a floor-mounted pedestal;

FIG. 3 is a front view the interactive retail customer interface of FIG. 1 provided in connection with a tabletop retail display fixture;

FIG. 4 is an illustration demonstrating use of interactive retail customer interfaces in accordance with the invention, showing the scanning of a product tag by a user;

FIG. 5 is a detail view of an interactive retail customer interface in accordance with the invention illustrating use by a user following scanning of a product tag;

FIG. 6 is a detail view of an interactive retail customer interface in accordance with the invention illustrating use by a user following scanning of a product tag showing selected product parameters;

FIG. 7 is a detail view of an interactive retail customer interface in accordance with the invention illustrating use by a user following scanning of a product tag showing scanned product details and display of a quick-response code for user interaction by use of a mobile device, as well as other navigation features displayed to the user;

FIG. 8 is a detail view of an interactive retail customer interface in accordance with the invention illustrating use by a user following scanning of a product tag showing scanned product details and subsequent scanning of a displayed quick-response code for user interaction on a mobile device;

FIG. 9 is a detail view of an interactive retail customer interface in accordance with the invention illustrating use by a user, and display of in-stock quantity of a scanned or subsequently selected product with selected size and color parameters;

FIG. 10 is a detail view of an interactive retail customer interface in accordance with the invention illustrating use by a user, showing alternate language capability, and displaying in-stock quantity of a scanned or subsequently selected product with selected size and color parameters, and other navigation options provided to a user;

FIG. 11 is a detail view of an interactive retail customer interface in accordance with the invention illustrating use by a user, displaying in-stock quantity of a scanned or subsequently selected product with selected size and color parameters, and other navigation options provided to a user;

FIG. 12 is a top view of two interactive retail customer interfaces in accordance with the invention illustrating the ability of one retail customer interface to provide data to another retail customer interface, in accordance with the invention;

FIG. 13 is an isometric view of an interactive retail customer interface according to a second embodiment of the present invention, integrated into a retail fitting room; and

FIG. 14 is an isometric view of an interactive retail customer interface according to a third embodiment of the present invention, integrated into a retail display fixture.

### DETAILED DESCRIPTION OF THE INVENTION

Reference will now be made to the drawings wherein like reference numerals identify similar structural features or aspects of the subject disclosure.

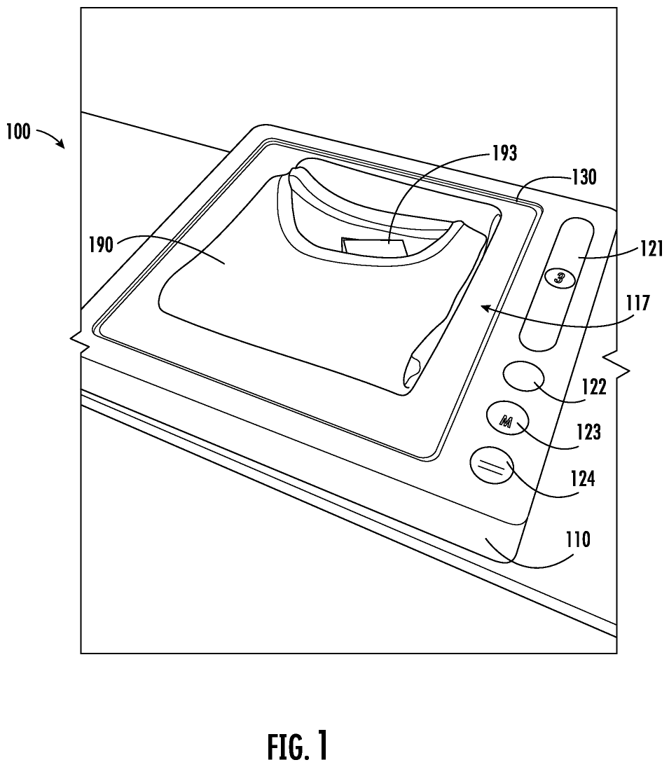

For purposes of explanation and illustration, and not limitation, an isometric view of an exemplary embodiment of an example interactive retail customer interface in accordance with the present invention is shown in FIG. 1 and is designated generally by reference character 100.

The interactive retail customer interface 100 includes a body 110, which houses the functional components of the interactive retail customer interface 100, including the visible, tactile, interactive and ancillary components thereof.

In the illustrated embodiment, display regions 121, 122, 123 and 124 are provided, which can be composed of individual display modules, or alternatively composed of a single underlying module, which in-turn can be integrated into the body 110 with functional or aesthetic divisions formed by the housing itself, as illustrated. In the illustrated embodiment, display regions 121, 122, 123 and 124 can also be touch-sensitive to allow a user to interact with the displayed data, as will be described in more detail below in connection with other figures.

The interactive retail customer interface 100 includes a sensor area 117 where a user can place or otherwise scan an item of interest. In the illustration of FIG. 1, a garment 190 having an RFID tag 193 is placed in the sensor area 117. One or more sensors are therefore provided within the body 110, in order to interact with ID tags or barcodes of objects of interest. The sensors can be of any suitable technology for the application, including various RFID and UHF RFID protocols, optical (e.g., bar code), and the like.

Depending on the precise implementation, the interactive retail customer interface 100 can be configured to automatically ignore RFID inventory control (security) tags, and only read product information RFID tags.

Further, the interactive retail customer interface 100 can scan multiple tags at the same time, and ask by way of the user interface, such as the display regions 121, 122, 123 and 124, which garment a user wants to select.

In accordance with the invention, user interaction data can be logged, especially when coupled with a quick-response (QR) code for the purpose of interacting with a user's mobile device—for example to make selections and/or to “buy now.” In that manner, user data can be utilized effectively, and potentially to cross-sell and upsell products.

The interactive retail customer interface 100 further includes a visual feedback feature in the form of an illuminated ring 130. In accordance with the invention, the illuminated ring 130 can be at least partially translucent can be embodied to provide multi-color feedback capability, depending on user actions or other information to be conveyed, such as by use of RGB and/ or RGBW LEDs and controller. For example, a default color (e.g., blue) can be displayed until a user scans an object, after which the interactive retail customer interface 100 confirms a successful tag scan by changing the color of the illuminated ring to a positive confirmation color (e.g., green) or, alternatively indication of an unsuccessful scan is indicated by display of an error color (e.g., red).

If a delay is necessary for information retrieval, the illuminated ring 130 can display a wait color (e.g., amber), and so on. Colors and manner of illumination (e.g., solid, pulsating) can be programmed into the controller of the interactive retail customer interface 100, as desired for respective scenarios. Alternatively, multi-color feedback can be enabled by multiple, discrete, single-color LEDs, such as by providing only two, only three or only four or only five single-color

LEDs selected from white, amber, green, red, blue, for example. In such embodiments, the illuminated ring can illuminate in only the embodied colors, such as white and amber, or only blue and red, or only red, white and blue, by illuminating one or more single color-LEDs. In certain figures, exemplary placement of discrete LED modules is indicated by a dash within the illuminated ring 130.

Alternatively still, the illuminated ring 130 can be embodied as a single color, such as by providing single-color LEDs or other light sources in connection therewith. If so desired, different lighting or blinking patterns can be provided to communicate different feedback. For example, a solid or gently pulsating glow can invite a customer to scan an item, a single solid on-off-on blink can confirm proper scanning of an item, and a rapid blink can indicate an error.

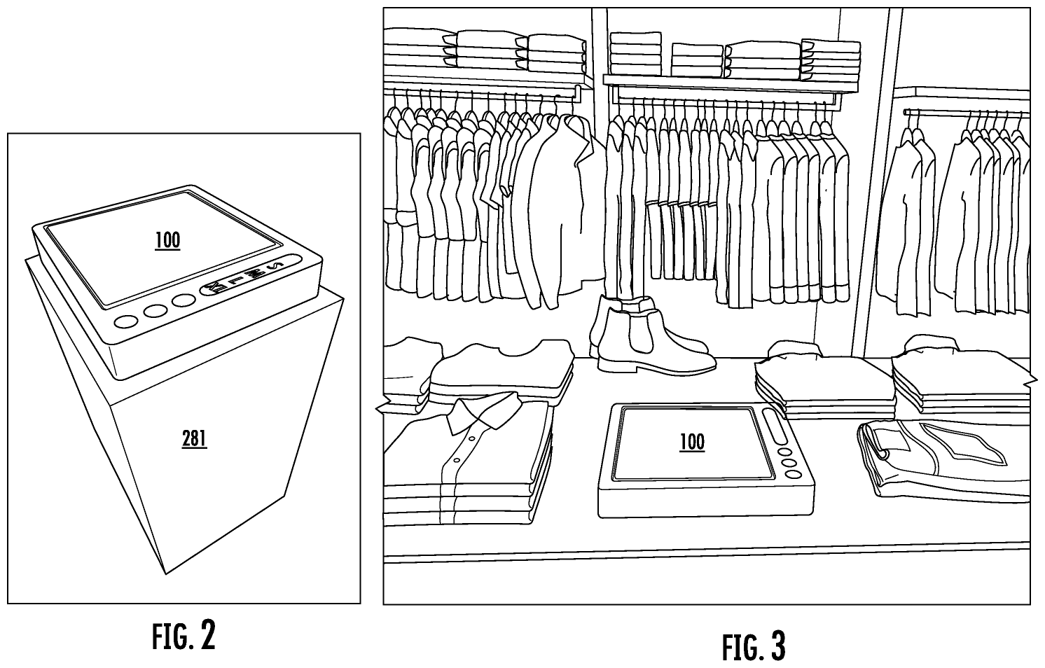

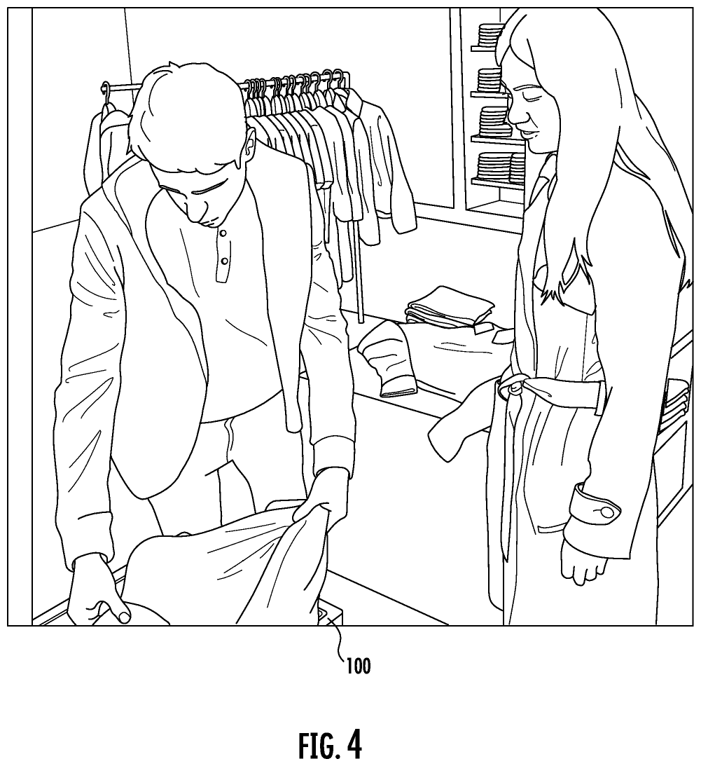

FIG. 2 is an isometric view of the interactive retail customer interface 100 of FIG. 1, provided in connection with a floor-mounted pedestal 281, while FIG. 3 is a front view the interactive retail customer interface 100, provided in connection with a tabletop retail display fixture, set among merchandise to allow a user easy access and quick answers to product availability questions. FIG. 4 is an illustration demonstrating use of the interactive retail customer interface 100, showing the scanning of a product tag by a user—in this case a store employee—scanning a product for a customer.

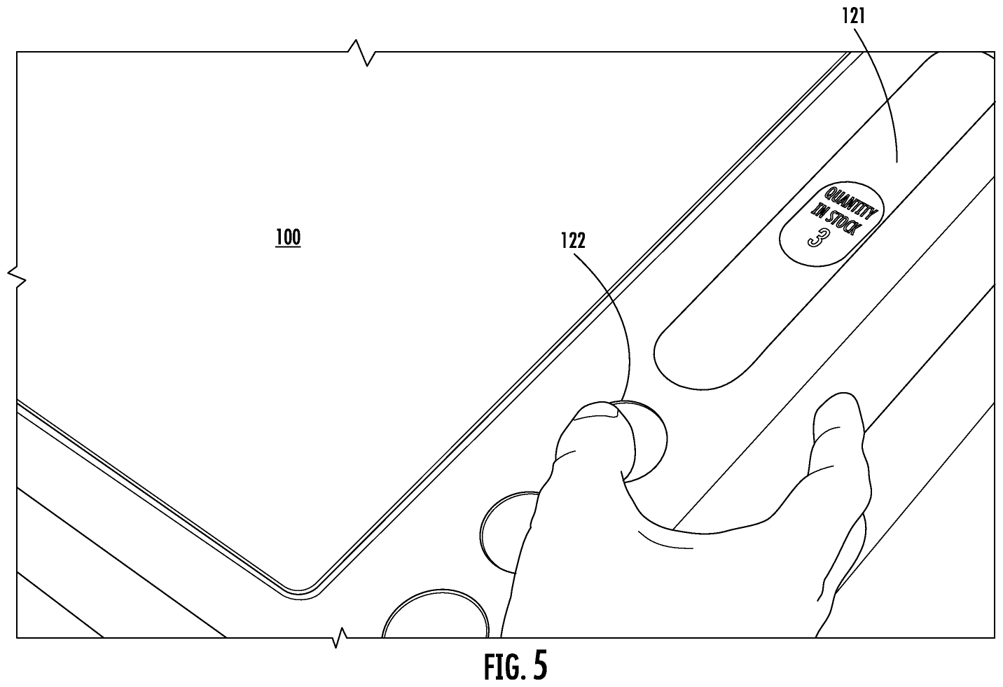

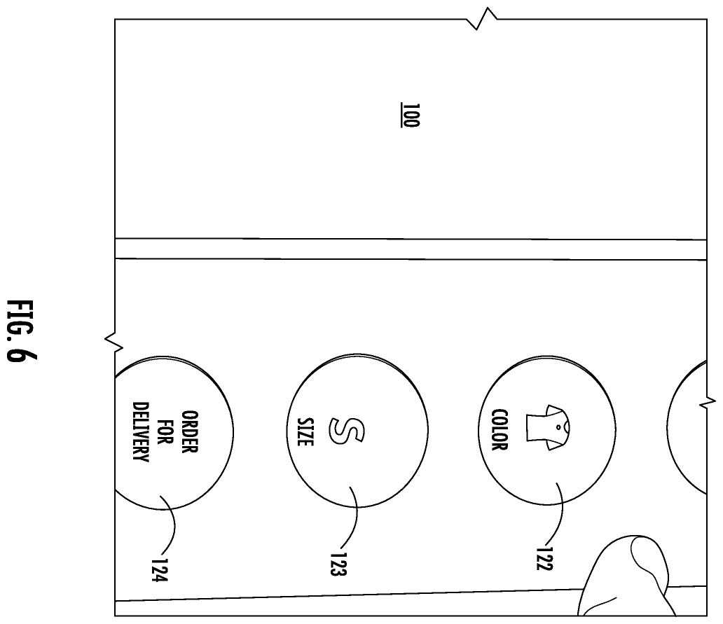

FIG. 5 is a detail view of the interactive retail customer interface 100 illustrating use by a user following scanning of a product tag, where total count of in-stock items is displayed in upper display region 121, while a user interacts with interactive region 122 to select different product characteristics of interest—in this case, product color.

FIG. 6 is a detail view of the interactive retail customer interface 100 illustrating use by a user following scanning of a product tag, showing selected product parameters of color in region 122 and size in region 123. Alternate parameters or navigation prompts can be displayed in other areas, such as region 124, which in the illustration is prompting a user with the option of ordering an item for delivery to their home.

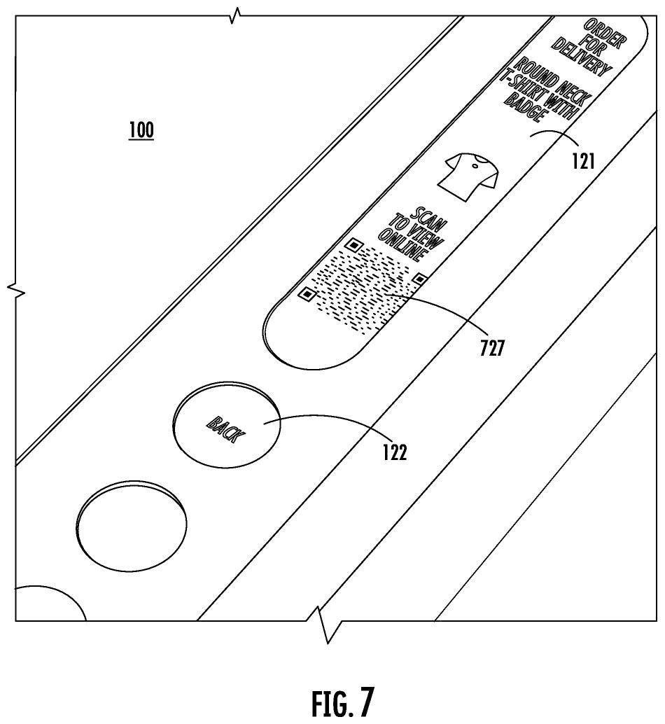

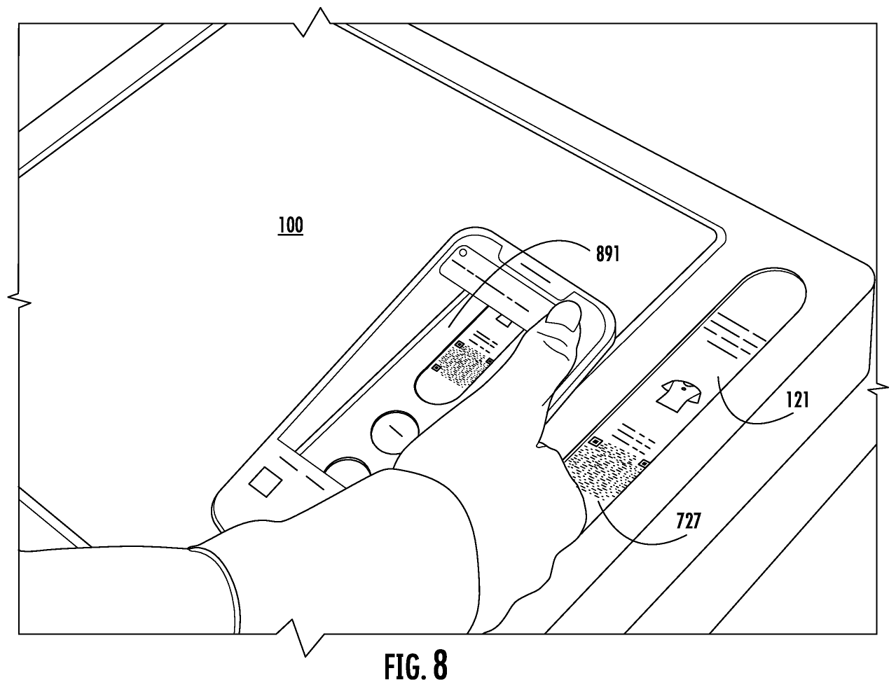

FIG. 7 is a detail view of the interactive retail customer interface 100 illustrating use by a user following scanning of a product tag showing scanned product details and display of a quick-response (QR) code 727 for user interaction by way of a mobile device, as well as other navigation features displayed to the user, such as the option to “go back” in region 122. FIG. 8 is a detail view of the interactive retail customer interface 100 showing scanning of the displayed quick-response code 727 with a mobile device 891. Depending on the precise implementation, the quick-response code can allow for touchless interaction by a user with the interactive retail customer interface 100, remotely through their mobile device 891. Alternative implementations can lead a user to a website product page of the product of interest, or to an input or transaction screen that can allow them to complete a transaction, optionally including payment, directly from their mobile device, or other functions.

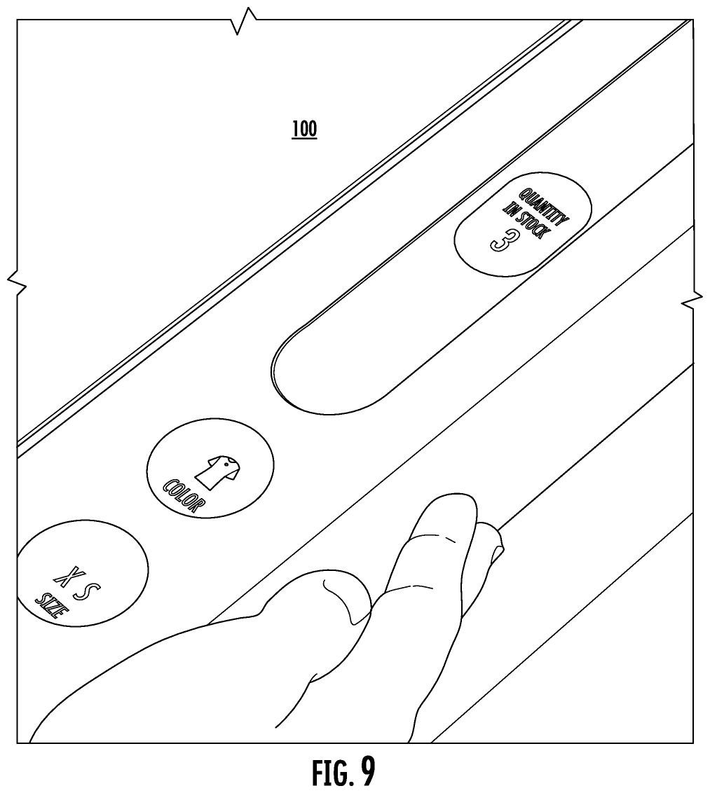

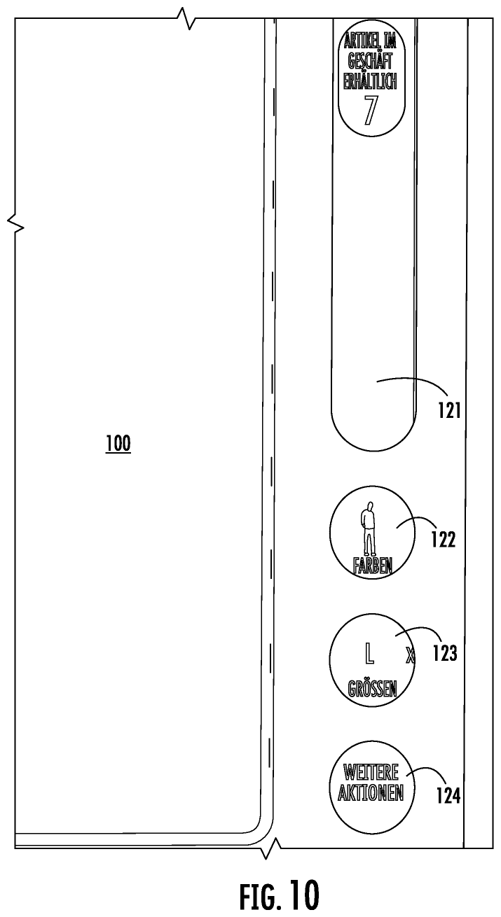

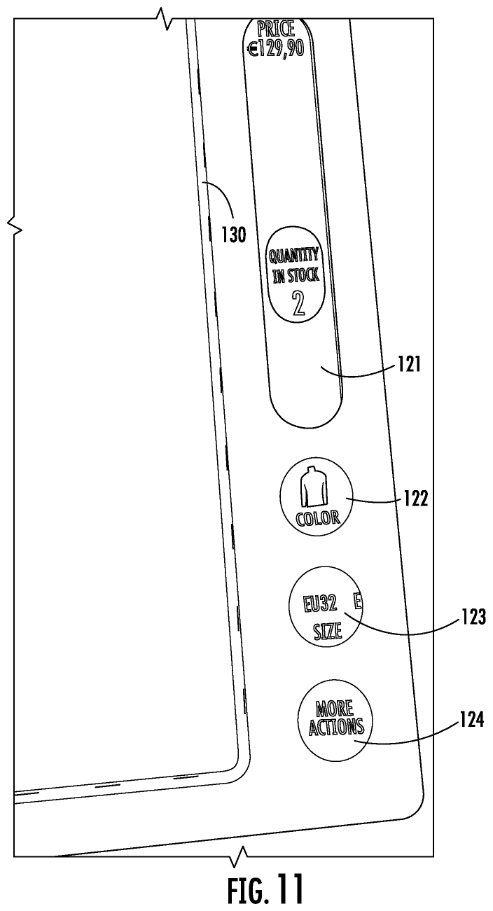

FIGS. 9, 10 and 11 are detail views of the interactive retail customer interface 100 illustrating use by a user, and display of in-stock quantity of a scanned or subsequently selected product with selected size and color parameters. Between FIGS. 9-11, different languages are displayed (English and German, respectively), any language can be displayed based on default settings, and/or user preferences. Accordingly, interactive retail customer interfaces in accordance with the invention can offer language selection to a user at the initiation of interaction and/or at any time during use. Display regions 121, 122, 123, and 124 can be programmed to display any relevant information or provide any desired functionality. In this case, region 121 is programmed to display real-time inventory data of product available in the store, while the parameter of fabric or color is shown in region 122, size in region 123 and optional other functions in region 124.

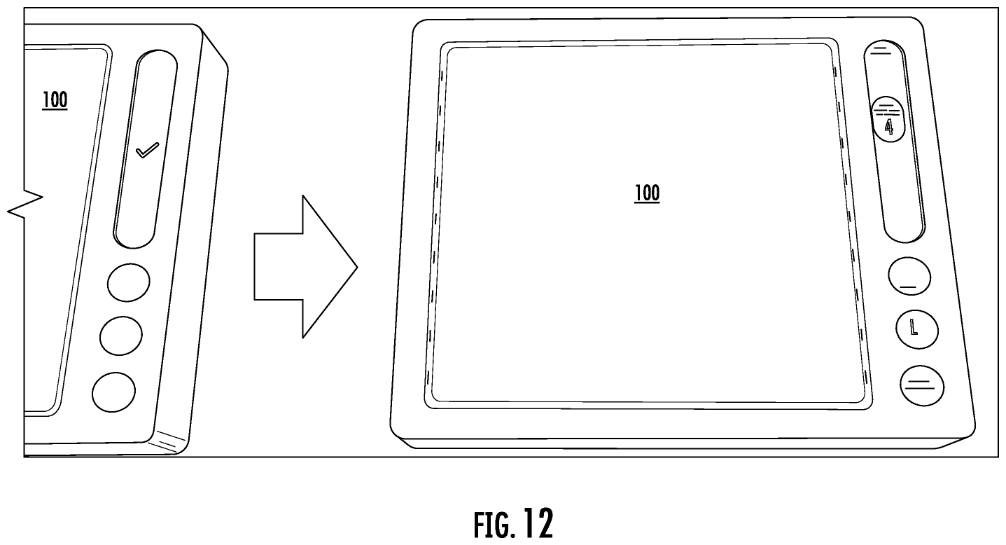

FIG. 12 is a top view of two interactive retail customer interfaces 100 in accordance with the invention illustrating the ability of one retail customer interface 100 to provide data to another retail customer interface 100. In the illustrated embodiment, an item or tag is scanned on one retail customer interface 100 (left) and the identifying information is sent to the other retail customer interface 100 (right). Such interaction can be beneficial in alternative implementations of retail customer interfaces in accordance with the invention.

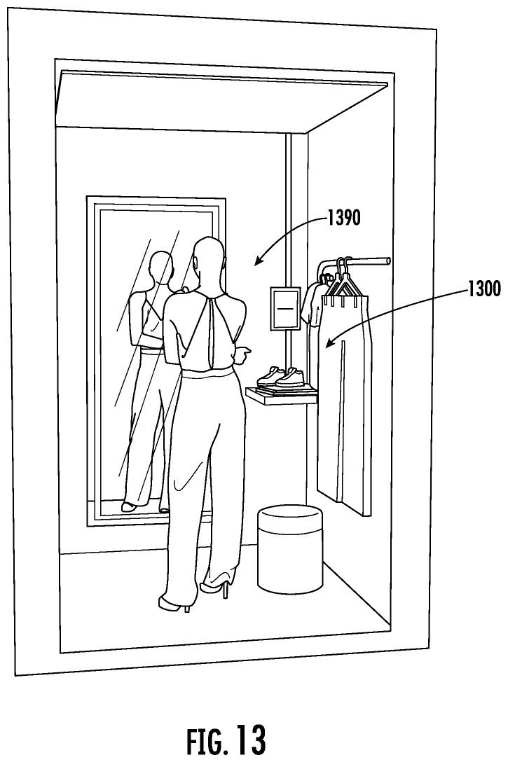

As illustrated in FIG. 13, an alternate embodiment of a retail customer interface 1300 is placed within a retail fitting room. A customer 1390 can scan an item in the room in the process of trying on an item. The user can interact with the retail customer interface 1300 directly to find a different size or color, or the product data can be sent to another retail customer interface, such as retail customer interface 100 or a separate stationary or mobile device outside of the fitting room, and being used by a retail employee assisting the customer 1390. The retail employee can then use the secondary retail customer interface 100 (or other device) to determine product availability, after which he or she can find and bring the product to the customer, still waiting in the fitting room. In this manner, there is no doubt what the product or garment of interest is, and the process of meeting the customer's requests is expedited with accuracy.

In accordance with the invention, multiple sensors can be provided, which can be integrated into the walls or other surfaces of the fitting room. In accordance with one aspect, multiple sensors can be provided at different heights for hanging garments, to allow for consistent scanning of tags, regardless of where the user places garments. In accordance with another aspect of the invention, one or more sensors can be specifically placed in a dedicated “no” area, for garments the user is not satisfied with. Once the system detects the presence of a garment in this area, the user interface can prompt a user to explain why the garment was not chosen. The system can then programmatically offer different sizes or colors, optionally automatically prompting a store employee to retrieve alternative garments or offer style advice to the user. Additionally or alternatively, the user interface can directly offer alternative options for selection.

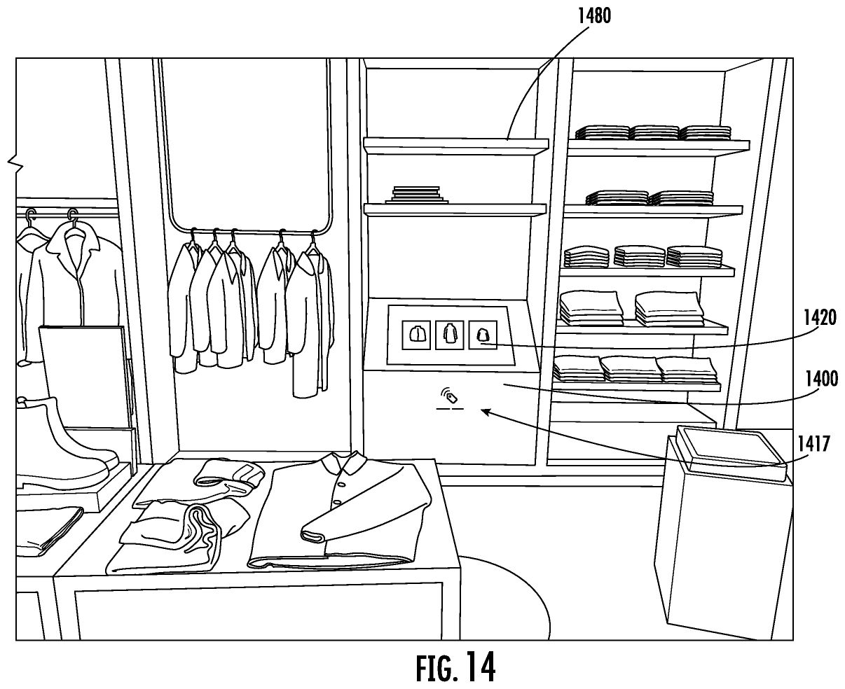

FIG. 14 is an isometric view of an interactive retail customer interface 1400 according to a third embodiment of the present invention, integrated into a retail display fixture 1480. In the illustrated embodiment, the retail customer interface 1400 includes a sensor area 1417 and display 1420, that are integrated into the display fixture 1480. The display 1420 can include touch-screen capability, and/or external interface buttons can be provided.

While the devices, systems and methods of the subject disclosure have been shown and described with reference to particular embodiments, those skilled in the art will readily appreciate that changes and/or modifications may be made thereto without departing from the spirit and scope of the subject disclosure. In particular, it is to be understood that features described in connection with one embodiment of the invention can be incorporated into other embodiments of the invention, even if not specifically discussed herein.

What is claimed is:

1. An interactive retail customer interface, comprising:
a housing defining the shape of the interactive retail customer interface, adapted and configured to secure and contain operable components of the interactive retail customer interface;
a sensor adapted and configured to receive identifying data related to a selected retail product;
a display adapted and configured to provide relevant information to a user relating to the selected retail product;
a user interface adapted and configured to receive user input in response to the displayed relevant information; and
a controller programmed to receive identifying data from the sensor, programmatically provide data to the display, and respond to user input from the user interface.

2. The interactive retail customer interface of claim 1, wherein the sensor is a radio-frequency ID sensor. sensor.

3. The interactive retail customer interface of claim 1, wherein the sensor is an optical

4. The interactive retail customer interface of claim 1, wherein the user interface includes one or more touch-sensitive screens.

5. The interactive retail customer interface of claim 1, wherein the user interface includes one or more physical buttons.

6. The interactive retail customer interface of claim 1, wherein the user interface includes a displayed quick response (QR) code, allowing a user to control the interface remotely through a mobile device.

7. The interactive retail customer interface of claim 1, further comprising a data connection to external database to retrieve inventory information.

8. The interactive retail customer interface of claim 7, wherein the data connection is wireless.

9. The interactive retail customer interface of claim 1, further comprising a power supply.

10. The interactive retail customer interface of claim 9, wherein the power supply is a battery.

11. The interactive retail customer interface of claim 1, further comprising an illuminated feedback indicator.

12. The interactive retail customer interface of claim 11, wherein the illuminated feedback indicator extends around a sensor area.

13. The interactive retail customer interface of claim 1, further comprising a floor-mounted pedestal.

14. The interactive retail customer interface of claim 1, wherein the interactive retail customer interface is integrated into a retail display fixture.

15. The interactive retail customer interface of claim 1, wherein the interactive retail customer interface is integrated into retail fitting room furniture.
